(19) United States
(12) Patent Application Publication
(10) Pub. No.: US 2026/0134639 A1
(43) Pub. Date: May 14, 2026

(54) ADAPTIVE AUGMENTED REALITY DISPLAY SYSTEM USING CAMERA-BASED INPUT

(71) Applicant: Flying Flamingos India Private Limited, Bangalore (IN)

(72) Inventors: Amit Gaiki, Bangalore (IN); Shourya Agarwal, Ajmer (IN); Malhar Patil, Nagpur (IN); Divyansh Gupta, Banswara (IN)

(73) Assignee: Flying Flamingos India Private Limited, Bangalore (IN)

(21) Appl. No.: 19/388,334

(22) Filed: Nov. 13, 2025

(30) Foreign Application Priority Data
Nov. 13, 2024 (IN) 202441087822

(51) Int. Cl. G06T 19/00; H04N 13/296

(52) U.S. Cl. CPC G06T 19/006; H04N 13/296

(57) ABSTRACT

A computer-implemented method, computing system, and non-transitory computer-readable medium for dynamic and adaptive mixed reality content display are provided. The method includes triggering a camera module of a communication device based on activation of a mixed reality experience, initiating the mixed reality experience on the communication device, receiving at least one input of a plurality of inputs in real time from the camera module, analyzing the at least one received input to determine one or more spatial characteristics of a physical environment around the communication device, dynamically and adaptively optimizing one or more virtual elements associated with the mixed reality content in real time based on a pre-defined threshold change in the at least one received input, and rendering the dynamically optimized mixed reality content based on the pre-defined threshold change. The optimization enables spatial coherence between the one or more virtual elements and the physical environment.

### CROSS-REFERENCE TO RELATED APPLICATIONS

The present application claims the benefit of Indian Provisional Patent Application No. 202441087822, filed Nov. 13, 2024, all of which are hereby incorporated by reference in their entirety for all purposes.

### TECHNICAL FIELD

The present disclosure relates to the field of mixed reality systems and methods. Specifically, the present disclosure relates to dynamic and adaptive rendering of mixed reality content on a communication device.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Mixed Reality (MR) technologies merge virtual and physical environments to create interactive and spatially consistent experiences. Modern MR systems enable digital content such as objects, overlays, or effects to be positioned and manipulated within the real world. Users can

access MR experiences through smartphones, tablets, and head-mounted displays equipped with embedded cameras and sensors. Conventional MR solutions often rely on static rendering pipelines that do not adapt efficiently to device capabilities or real-time environmental changes. Additionally, high-fidelity MR applications frequently require significant device resources, limiting performance on consumer-grade hardware. To support scalable and device-agnostic MR deployments, there is a need for a modular and adaptive architecture that dynamically optimizes virtual content based on hardware performance, environmental input, and user context.

### SUMMARY

In a first aspect, the present disclosure provides a computing system for dynamic and adaptive mixed reality content display at a communication device. The computing system includes one or more processors and a memory. The memory stores instructions that cause the one or more processors to trigger a camera module of the communication device based on activation of a mixed reality experience. The camera module is triggered by detecting a trigger action of a plurality of triggering actions. In addition, the memory stores instructions that cause the one or more processors to initiate the mixed reality experience on the communication device in response to the trigger action. Moreover, the memory stores instructions that cause the one or more processors to receive at least one input of the plurality of inputs of a plurality of inputs in real time from the camera module of the communication device during rendering of the mixed reality content. Further, the memory stores instructions that cause the one or more processors to analyze the at least one received input of the plurality of inputs to determine one or more spatial characteristics of a physical environment around the communication device. Next, the memory stores instructions

that cause the one or more processors to dynamically and adaptively optimize one or more virtual elements associated with the mixed reality content in real time based on a pre-defined threshold change in the at least one received input of the plurality of inputs from the camera module of the communication device. The optimization enables spatial coherence between the one or more virtual elements associated with the mixed reality content and the corresponding physical environment captured through the camera module. Further, the memory stores instructions that cause the one or more processors to render the dynamically optimized mixed reality content based on the pre-defined threshold change. The mixed reality content is rendered using at least one mixed reality module of a plurality of mixed reality modules. The dynamically optimized mixed reality content includes at least the one or more virtual elements anchored in accordance with at least a spatial position and orientation of the communication device. The one or more processors and the memory cooperate with the camera module to dynamically manage computational and graphical workloads. The cooperation reduces frame lag, improves spatial coherence, and enhances device-level rendering efficiency during the real-time mixed reality display.

In an embodiment of the present disclosure, the plurality of triggering actions corresponds to a mode for initiating a device-agnostic access to the mixed reality content. The plurality of triggering actions includes at least scanning of a Quick Response (QR) code through a camera module of the communication device, clicking on a hyperlink received on the communication device, and detection of a near field communication (NFC) tag through the communication device.

In an embodiment of the present disclosure, the rendering of the mixed reality content on the communication device includes recognizing a usage context associated with hardware capabilities of the communication device and environment data in real time, identifying at least one mixed reality (MR) module from a plurality of mixed reality modules of a modular mixed

reality engine based on the usage context recognition in real time and dynamically loading the at least one identified mixed reality module within a secure execution framework. The at least one identified mixed reality module is configured to render the mixed reality content.

In an embodiment of the present disclosure, the plurality of inputs includes at least one of a spatial positioning data of the communication device, an orientation data of the communication device, a depth data between the camera module and one or more virtual elements, and one or more optical parameters. The plurality of inputs are received continuously during the mixed reality experience for facilitating the dynamic optimization, adaptive rendering fidelity, and context-aware responsiveness of the mixed reality experience.

In an embodiment of the present disclosure, the depth data is received from a depth sensor of the communication device to dynamically optimize the rendered mixed reality content by enabling one or more of depth-based scaling, occlusion handling, and spatial alignment of the one or more virtual elements with the physical environment.

In an embodiment of the present disclosure, the analysing includes determining one or more spatial characteristics of a physical environment using the at least one input, identifying, based on the at least one input, one or more reference features within the physical environment for anchoring virtual 3D elements, estimating position and orientation of the communication device relative to the one or more reference features using motion tracking techniques and rendering and displaying 3D virtual content that is spatially aligned with the physical environment based on the position estimation and the one or more spatial characteristics.

In an embodiment of the present disclosure, the one or more spatial characteristics includes at least spatial geometry, depth information, surface textures, object boundaries, user viewpoint angle, and relative motion of the communication device with respect to at least one of one or more reference points in the physical environment, previously mapped spatial coordinates, and the rendered one or more virtual elements.

In an embodiment of the present disclosure, the pre-defined threshold change in the received at least one input of a plurality of inputs includes a variation in at least one of a spatial position, an orientation, depth data exceeding a pre-defined value and one or more optical parameters. The dynamic and iterative optimization of the mixed reality content is triggered upon detection of the variation to minimize recalculations and ensure rendering efficiency.

In an embodiment of the present disclosure, the dynamic optimization is done based on a combination of a depth data received from a depth sensor of the communication device and the at least one input of the plurality of inputs received from a camera sensor of the communication device.

In an embodiment of the present disclosure, the dynamic optimization of the mixed reality content includes adjusting positions of the one or more virtual elements in real time based on the at least one input related to change in spatial positioning, scaling, depth alignment, or occlusion handling based on the user’s real-time viewpoint.

In an embodiment of the present disclosure, the one or more processors are further configured to perform motion tracking to determine a movement pattern of the user in relation to the physical environment by capturing a sequence of images of the physical environment, analyzing one or more changes in visual features across consecutive frames to determine translational and rotational movement of the communication device and enabling, based on the analysis, synchronized transitions and responsive adaptation of the mixed reality content in accordance with the motion of the user.

In an embodiment of the present disclosure, the one or more optical parameters include at least one of a focal length, a zoom type and level, and field of view derived from the camera module. The mixed reality content is dynamically adjusted based on the one or more optical parameters to maintain accurate spatial proportion, visual consistency, and alignment of virtual objects with the physical environment.

In an embodiment of the present disclosure, the method further includes adjusting a scale of a virtual 3D overlay in the rendered mixed reality content based on occurrence and detection of an optical zoom event associated with a lens of the camera module in real time. The scale of the virtual 3D overlay is adjusted such that the virtual 3D overlay align according to a real time zoomed-in perspective of the lens to maintain at least spatial consistency, proportional accuracy and visual coherence between the one or more virtual elements and the physical environment.

In an embodiment of the present disclosure, the method further includes receiving an image stabilization feedback from at least one of an optical image stabilization (OIS) or electronic image stabilization (EIS) system of the camera module. The image stabilization feedback is utilized to maintain accurate anchoring and reduce jitter of the rendered mixed reality content during movement of the communication device.

In a second aspect, the present disclosure provides a computer-implemented method for dynamic and adaptive mixed reality content display at a communication device. The method includes triggering a camera module of the communication device based on activation of a mixed reality experience. The camera module is triggered by detecting a trigger action of a plurality of triggering actions. In addition, the method includes initiating the mixed reality experience on the communication device in response to the trigger action. Moreover, the method includes receiving at least one input of the plurality of inputs of a plurality of inputs in real time from the camera module of the communication device during rendering of the mixed reality content. Further, the method includes analyzing the at least one received input of the plurality of inputs to determine one or more spatial characteristics of a physical environment around the communication device. Next, the method includes dynamically and adaptively optimizing one or more virtual elements associated with the mixed reality content in real time based on a pre-defined threshold change in the at least one received input of the plurality of inputs from the camera module of the communication device. The optimization enables spatial coherence between the one or more virtual elements associated with the mixed reality content and the corresponding physical environment captured through the camera module. Further, the method includes rendering the dynamically optimized mixed reality content based on the pre-defined threshold change. The mixed reality content is rendered using at least one mixed reality module of a plurality of mixed reality modules. The dynamically optimized mixed reality content includes at least the one or more virtual elements anchored in accordance with at least a spatial position and orientation of the communication device. The dynamic optimization and the rendering are performed through hardware-level cooperation between a processor associated with the communication device, display unit, and the camera module. The hardware-level cooperation improves real-time frame stability, reduces rendering latency, and enhances spatial alignment accuracy during the mixed reality content display.

In a third aspect, a non-transitory computer-readable medium is disclosed. The non-transitory computer-readable medium stores computer-executable instructions which, when executed by one or more processors of a computing device, cause the computing device to perform a method for dynamic and adaptive mixed reality content display. The method includes triggering a camera module of the communication device based on activation of a mixed reality experience. The camera module is triggered by detecting a trigger action of a plurality of triggering actions. In addition, the method includes initiating the mixed reality experience on the communication device in response to the trigger action. Moreover, the method includes receiving at least one input of the plurality of inputs of a plurality of inputs in real time from the camera module of the communication device during rendering of the mixed reality content. Further, the method includes analyzing the at least one received input of the plurality of inputs to determine one or more spatial characteristics of a physical environment around the communication device. Next, the method includes dynamically and adaptively optimizing one or more virtual elements associated with the mixed reality content in real time based on a pre-defined threshold change in the at least one received input of the plurality of inputs from the camera module of the communication device. The optimization enables spatial coherence between the one or more virtual elements associated with the mixed reality content and the corresponding physical environment captured through the camera module. Further, the method includes rendering the dynamically optimized mixed reality content based on the pre-defined threshold change. The mixed reality content is rendered using at least one mixed reality module of a plurality of mixed reality modules. The dynamically optimized mixed reality content includes at least the one or more virtual elements anchored in accordance with at least a spatial position and orientation of the communication device. The execution of the instructions causes hardware-level adaptation of rendering parameters of the communication device. The hardware-level adaptation enables optimized synchronization between the one or more processors and the camera module. In addition, the hardware-level adaptation reduces computational overhead during the real-time mixed reality rendering.

### BRIEF DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 illustrates an interactive computing environment for dynamic and adaptive mixed reality content display, in accordance with various embodiments of the present disclosure;

FIG. 2 illustrates an exemplary block diagram of a computing system for the dynamic and adaptive mixed reality content display, in accordance with various embodiments of the present disclosure;

FIG. 3 illustrates an exemplary environment for enabling trigger-based instantiation and modular deployment of mixed reality content, in accordance with various embodiments of the present disclosure;

FIG. 4 illustrates a flow chart of a method for the dynamic and adaptive mixed reality content display, in accordance with various embodiments of the present disclosure; and

FIG. 5 illustrates a block diagram of an exemplary device configured for the dynamic and adaptive mixed reality content display, in accordance with various embodiments of the present disclosure.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote features throughout the specification and figures.

### DETAILED DESCRIPTION

In the following description of the disclosure and embodiments, reference is made to the accompanying drawings in which it is shown by way of illustration of specific embodiments that can be practiced. It is to be understood that other embodiments and examples can be practiced, and changes can be made without departing from the scope of the disclosure.

Although the following description uses the terms “first,” “second,” etc. to describe various elements, these elements should not be limited by the terms. These terms are only used to distinguish one element from another. For example, a first input could be termed a second input, and, similarly, a second input could be termed a first input, without departing from the scope of the various described examples. The first input and the second input can both be outputs and, in some cases, can be separate and different inputs.

The terminology used in the description of the various described examples herein is for the purpose of describing specific examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

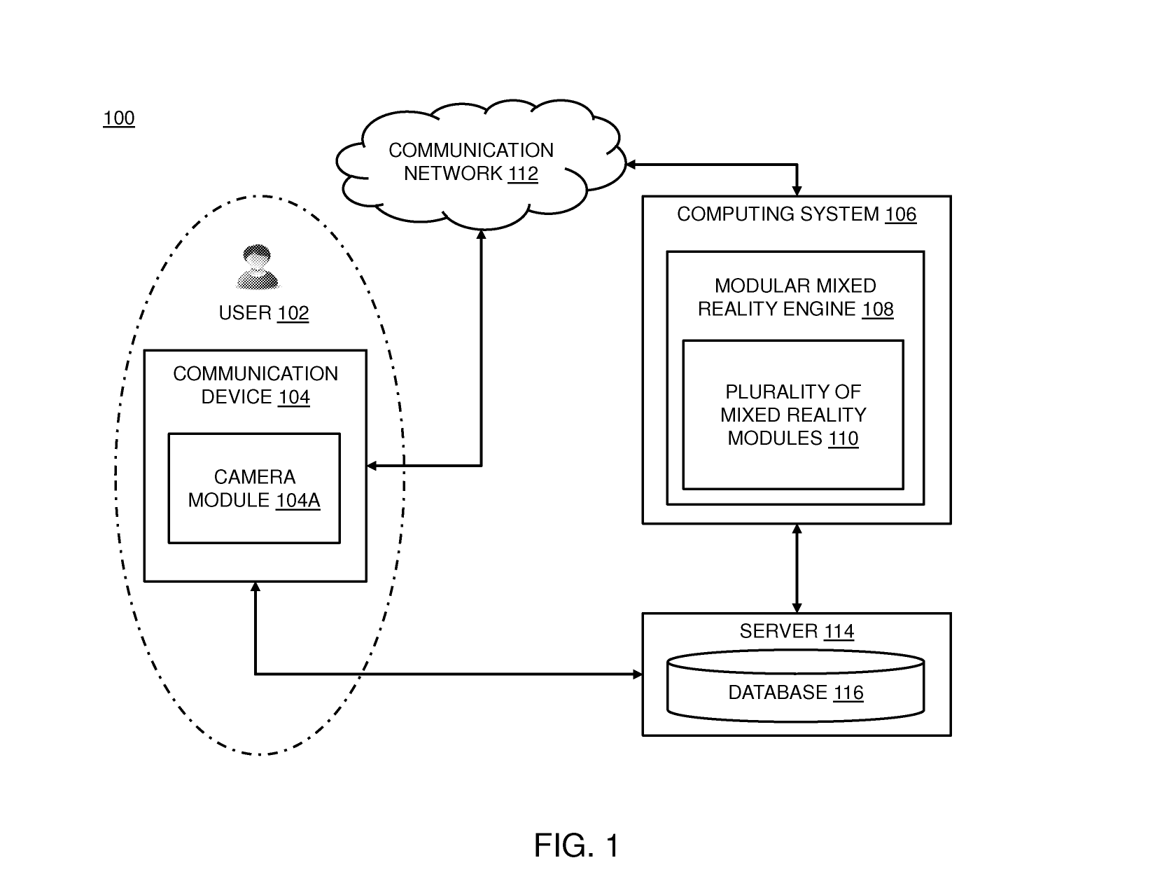

FIG. 1 illustrates an interactive computing environment 100 for dynamic and adaptive mixed reality content display, in accordance with various embodiments of the present disclosure. The interactive computing environment 100 is configured to render mixed reality content at a communication device 104. The interactive computing environment 100 includes a communication device 104 associated with a user 102, a computing system 106, a communication network 112, a server 114 and a database 116. The communication device 104 interacts with the computing system 106 via the communication network 112. The components of the interactive computing environment 100 cooperate to render a mixed reality experience on the communication device 104. The components of the interactive computing environment 100 are operatively coupled and cooperatively function to enable dynamic deployment, and rendering of the mixed reality content tailored to contextual and device-specific conditions.

The mixed reality experience refers to a digitally enhanced immersive environment that blends virtual objects or augmentations with the physical world or environment in real time. The mixed reality experience allows the user 102 to perceive and interact with at least one or more digital and one or more physical components in a spatially and temporally coherent manner. The mixed reality content encompasses at least digital assets, virtual objects, holograms, spatial audio, interactive controls, and context-sensitive information rendered within the mixed reality experience. The mixed reality content is rendered in real time based on user input, environmental conditions, sensor data, and device capabilities. In addition, the mixed reality content includes dynamic overlays, gesture-responsive elements, or real-world object annotations.

In an embodiment of the present disclosure, the communication device 104 refers to any suitable user equipment configured to receive, render, and interact with the mixed reality content. Examples of the communication device 104 include a smartphone, tablet, smart glasses, wearable computing device, augmented reality (AR) headsets, and the like. Additionally, the communication device 104 may host a runtime environment capable of executing instant or transient mixed reality modules without requiring full application installation. The communication device 104 includes a camera module 104a. In an embodiment of the present disclosure, the camera module 104a includes a camera sensor, a depth sensor, and the like.

In an embodiment of the present disclosure, the camera module 104A corresponds to a hardware imaging component integrated within or operatively coupled to the communication device 104. The camera module 104A includes at least one of a color image sensor, a depth sensor, a time-of-flight (ToF) sensor, or an infrared (IR) sensor configured to capture real-time visual and spatial data from the physical environment. The camera module 104A captures image frames, depth maps, and spatial features used by the computing system 106 to determine spatial geometry, surface topology, and environmental context. The data acquired by the camera module 104A is processed by the computing system 106 and the modular mixed reality engine 108 to generate spatially coherent overlays and anchored virtual objects. In an embodiment of the present disclosure, the camera module 104A provides continuous real-time input to the computing system 106 for enabling adaptive rendering, motion tracking, and context-aware synchronization of virtual elements within the mixed reality experience.

The user 102 may represent an individual interacting with the mixed reality content through the communication device 104. The user 102 may initiate mixed reality experiences by scanning a Quick Response (QR) code, clicking an app link, or triggering the modular mixed reality engine 108 via other scannable or link-based mechanisms.

Further, the computing system 106 may include one or more processors, memory units, and a rendering engine configured to generate and deliver the mixed reality content to the communication device 104. The rendering engine may leverage spatial mapping data, object recognition modules, or user-specific behavioral profiles to adapt the mixed reality content in real time. Additionally, the communication network 112 may include wired or wireless channels, such as 5G, Wi-Fi, or satellite links, to facilitate low-latency content synchronization and interaction. The server 114 may manage user sessions, content orchestration, and system-wide updates, while the database 116 may store user profiles, contextual data, device parameters, and pre-rendered or modular content components.

In an embodiment of the present disclosure, the computing system 106 includes a modular mixed reality engine 108. The modular mixed reality engine 108 includes a plurality of mixed reality modules 110. In an embodiment of the present disclosure, the modular mixed reality engine 108 corresponds to a hardware-integrated software framework configured to orchestrate the execution of one or more mixed reality modules within the computing system 106. The modular mixed reality engine 108 orchestrates loading of at least one module of the plurality of mixed reality modules 110 in real-time. The dynamic loading of the at least one module is done based at least on one or more user interactions and environmental data. The dynamic loading feature ensures an optimized performance and user experience. In an implementation, the modular mixed reality engine 108 may be a modular and platform-agnostic MR engine. The computing system 106 allows seamless deployment of the mixed reality content by leveraging real-time context awareness, dynamic module loading, and lightweight instant applications.

In another embodiment of the present disclosure, the modular mixed reality engine 108 may orchestrate unloading of at least one module of the plurality of mixed reality modules 110 in real-time. The dynamic unloading of the at least one module is done based at least on one or more user interactions and environmental data. The dynamic loading feature ensures an optimized performance and user experience. In an implementation, the modular mixed reality engine 108 may be a modular and platform-agnostic MR engine. The computing system 106 allows seamless deployment of the mixed reality content by leveraging real-time context awareness, dynamic module loading, and lightweight instant applications.

The plurality of mixed reality modules 110 operate within a kernel-level application sandbox or a secure sandbox environment in a Linux-based system to provide security and efficiency. In an embodiment of the present disclosure, the secure sandbox environment is established through context-aware permission management and a secure execution framework. The secure sandbox environment ensures at least security and stability during the rendering of the mixed reality content.

In an embodiment of the present disclosure, the computing system 106 enables adaptive data streaming for adjusting data streaming rates based on network conditions and device performance while integrating edge computing for efficiency. In an embodiment of the present disclosure, the computing system 106 enables a cross-module communication for facilitating real-time data exchange between at least two modules of the plurality of mixed reality modules 110. In addition, the cross-module communication enhances realism of the mixed reality experience through seamless interaction between 2D alpha content and 3D environment mapping.

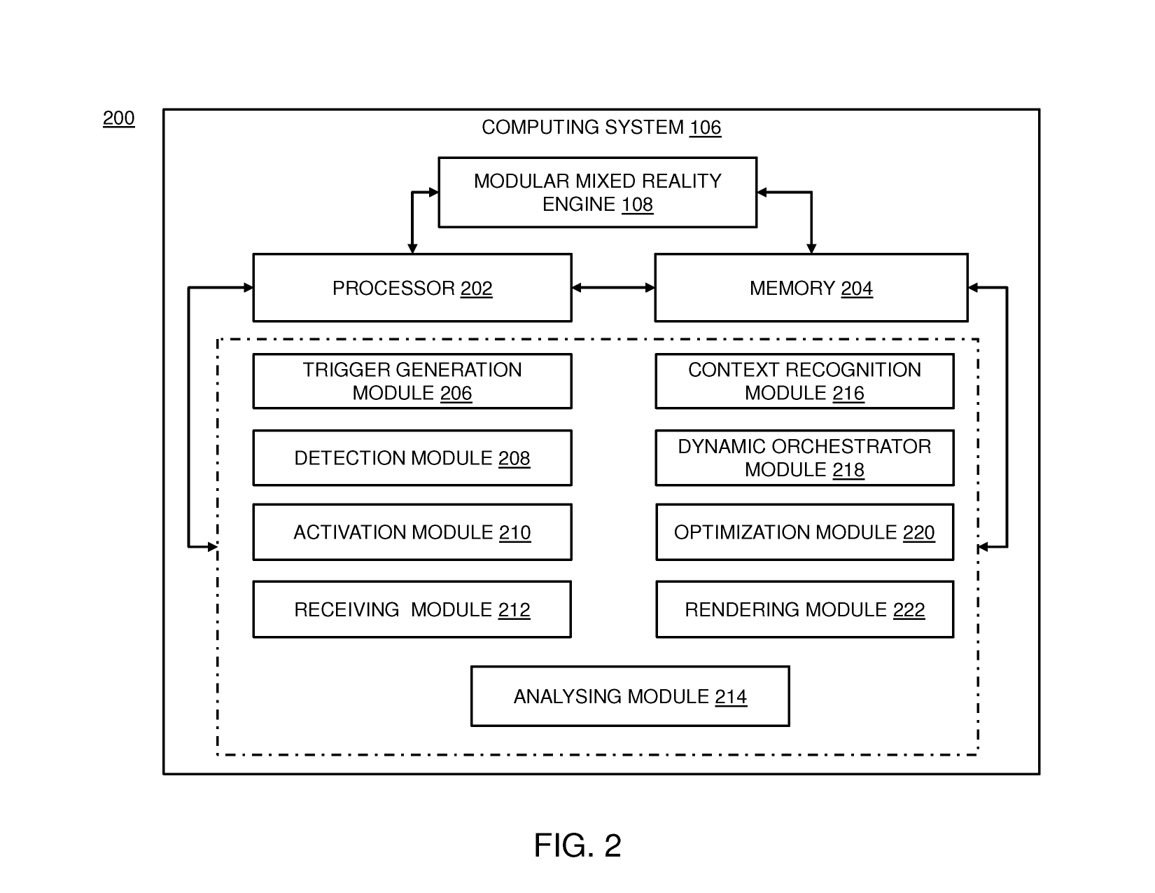

The communication device 104 works in conjunction with the computing system 106, the server 114 and the modular mixed reality engine 108 to perform a set of functions. The set of functions include at least reception of contextual data, dynamically loading appropriate one or more mixed reality modules, and rendering immersive content responsive to real-time user interactions and environmental conditions (explained further below in the detailed description of FIG. 2).

The communication network 112 serves as the backbone of the interactive computing environment 100, enabling seamless communication between the communication device 104, the computing system 106, the server 114 and the database 116. Various entities in the environment 100 may connect to the communication network 112 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G), 6th Generation (6G) communication protocols, Long Term Evolution (LTE) communication protocols, future communication protocols or any combination thereof.

The communication network 112 provides an infrastructure for seamless communication between the communication device 104, the computing system 106, the server 114 and the database 116. In some implementations, the communication network 112 includes internet, intranet, Wi-Fi, or other wired or wireless communication technologies.

The server 114 may refer to a backend processing system or a cloud-based infrastructure configured to coordinate, manage, and support the delivery of mixed reality content to the communication device 104. In an embodiment of the present disclosure, the server 114 includes one or more computing devices configured to manage backend operations. The operations include but are not limited to, processing user requests, storing and updating MR content modules, and executing cloud-based rendering operations. In addition to above, the server 114 may manage user sessions and maintain communication with the communication device 104. The server 114 may incorporate application programming interfaces (APIs), load-balancing modules, analytics engines, and orchestration logic to dynamically coordinate mixed reality experiences across users and devices.

In an embodiment of the present disclosure, the server 114 is associated with one or more remote computing entities. The one or more remote computing entities are responsible for facilitating core services required for managing and supporting the delivery of the mixed reality (MR) experiences. The server 114 operates as an orchestrator that communicates with the computing system 106 and the communication device 104 over the communication network 112. In one example, the server 114 may host APIs, decision engines, and application services configured to process user interactions, manage MR session states, authenticate user access, and deliver relevant MR content modules to downstream components.

In certain implementations, the server 114 may enforce access controls, implement deployment policies, and manage caching of frequently accessed MR assets to enhance responsiveness and delivery speed. The server 114 plays a key role in mediating communication between the modular mixed reality engine 108 on the communication device 104 and the backend infrastructure. The server 114 enables seamless synchronization and dynamic loading of the one or more mixed reality modules across heterogeneous client platforms.

In an embodiment of the present disclosure, the server 114 and the computing system 106 are architecturally distinct but interoperable components of the interactive computing environment 100. The server 114 and the computing system 106 perform complementary functions to facilitate MR content delivery and interaction. The server 114 acts as a backend orchestrator and processing layer, implemented using centralized or distributed cloud resources. It is configured to manage session states, execute intensive computational operations such as spatial computation and scene analysis, personalize MR content, and transmit context-aware MR assets to client-side rendering components.

The server 114 may refer to a backend processing system or cloud-based infrastructure that coordinates, manages, and supports the rendering of the mixed reality content delivered to the communication device 104. In an embodiment of the present disclosure, the server 114 and the computing system 106 represent architecturally distinct yet interoperable components of the interactive computing environment 100. Each of the server 114 and the computing system 106 are configured to perform complementary functions in support of the mixed reality content delivery and interaction. The server 114 functions as a backend processing and orchestration layer, implemented as a cloud-based infrastructure or centralized computing resource. The server 114 is configured to manage user sessions, perform computationally intensive operations such as spatial computation, scene understanding, and MR content personalization, and deliver contextually relevant MR assets to client-side components.

The server 114 may host, manage and remotely execute an instant application mechanism for enabling the dynamic delivery of the one or more mixed reality modules and ensuring platform and device independent user experiences. The server 114 may serve as an edge computing or localized processing layer that interfaces directly with the communication device 104. The server 114 is configured to handle real-time operations. The operations include at least adaptive user interface control, haptic feedback coordination, sensor data ingestion, and latency-sensitive mixed reality content rendering.

In an example implementation of a distributed computing environment and shown in FIG. 1, the computing system 106 is operatively connected to the server 114. The server 114 handles client requests and provides necessary data to the computing system 106 for further processing and rendering of mixed reality content. The computing system 106 and the server 114 are communicatively coupled via the communication network 112. The computing system 106 and the server 114 cooperatively function to enable scalable, immersive, and responsive mixed reality experiences across heterogeneous devices and usage contexts.

In another example implementation, the computing system 106 includes or is operatively connected to the database 116 for storing localized content or cached user session data (not shown in illustration). The computing system 106 includes a modular mixed reality engine and is operatively connected to a server 114 hosting the database 116. The server 114 handles client requests and provides necessary data to the computing system 106 for further processing and rendering of mixed reality content.

The computing system 106 may include a combination of software components, processing units, micro services, or virtualized containers that handle multiple tasks. The tasks include module selection, compatibility evaluation, mixed reality asset delivery, spatial computation, and the like. The computing system 106 herein may represent a cloud server, an edge computing node, or a centralized processing system. In an embodiment of the present disclosure, the computing system 106 includes the database 116. In another embodiment, the database 116 is associated and remotely connected to the computing system 106. In one implementation, the computing system 106 may include one or more server-grade machines or distributed cloud-based computing resources configured to perform the rendering of the mixed reality content. The computing system 106 may further include a plurality of software modules and processing components operative to execute the rendering of the mixed reality content. In an example implementation scenario, the rendering may include data pre-processing, feature extraction, segmentation model inference, and post-processing operations.

The database 116 refers to one or more data storage systems that store structured and unstructured information necessary for supporting and rendering the mixed reality experience. In an embodiment of the present disclosure, the database 116 herein may correspond to a non-transitory storage system caused to persistently store real time information for the rendering of the mixed reality content. The database 116 may include at least mixed reality module repositories, user profiles, mixed reality experience identifiers (IDs), device compatibility matrices, content metadata, and environmental context logs. In addition, the database 116 may contain pre-trained machine learning models used for dynamic prediction of the one or more mixed reality modules. The database 116 enables real-time data retrieval and synchronization across the computing system 106 and the server 114 to ensure that relevant mixed reality assets are efficiently selected, delivered, and rendered at the communication device 104. The database 116 may be implemented as a distributed cloud database or a hybrid architecture to support scalability, redundancy, and low-latency data access.

The database 116 herein may correspond to a collection of information that is organized so that it can be easily accessed, managed and updated. In some implementations, the database 116 may include relational databases, NoSQL databases, cloud-based databases, graph databases, in-memory databases, and the like.

In an embodiment of the present disclosure, the server 114 exists as an external host for the computing system 106 (as shown in FIG. 1). The database 116 may be integrated within the server 114. In another embodiment, the server 114 may host the computing system 106 (not shown in FIG. 1). The database 116 may be integrated within the server 114 for retrieving at least mixed reality assets, spatial data, and user interaction logs.

It is shown in FIG. 1 that a single user (the user 102) interacts with a single device (the communication device 106); however, it will be appreciated by those skilled in the art that any number of users 102 can simultaneously interact with the corresponding devices in real-time.

The number and arrangement of systems, and/or networks shown in FIG. 1 are provided as an example. There may be additional systems, devices, and/or networks; fewer systems, devices, and/or networks; different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems or a set of devices of the interactive computing environment 100 may perform one or more functions described as being performed by another set of systems or another set of devices of the interactive computing environment 100.

FIG. 2 illustrates an exemplary block diagram 200 of the computing system 106 for rendering the mixed reality content at the communication device 104, in accordance with various embodiments of the present disclosure. Please note that in order to explain system elements of FIG. 2, references might be made to the system elements of FIG. 2 for clarity and ease.

The computing system 106 includes the one or more processors, such as a processor 202. In addition, the computing system 106 includes a memory 204 and the modular mixed reality engine 108, a trigger generation module 206, a detection module 208, an activation module 210, a receiving module 212 and an analysing module 214. Furthermore, the computing system 106 includes a context recognition module 216, a dynamic orchestrator module 218, an optimization module 220 and a rendering module 222. In an embodiment, the dynamic orchestrator module 218 includes a selection module and a loading module. It should be noted that the above mentioned system elements are exemplary system elements; however, there may be more system elements for the computing system 106.

In an embodiment of the present disclosure, the processor 202 corresponds to one or more hardware-based processing units configured to execute machine-readable instructions stored in the memory 204. The processor 202 may include at least one of a central processing unit (CPU), a graphics processing unit (GPU), a digital signal processor (DSP), a neural processing unit (NPU), or a combination thereof. The processor 202 performs low-level computation, instruction execution, and task scheduling to facilitate the real-time mixed reality (MR) content rendering. The processor 202 cooperates with the modular mixed reality engine 108 and the camera module 104A to process the sensor data, execute the context-recognition algorithms, and dynamically allocate the computational resources for the rendering and the optimization of the mixed reality content. The hardware-based execution of the processor 202 enables real-time frame generation, spatial tracking, and latency minimization during the display of mixed reality content on the communication device 104.

The memory 204 stores instructions that, when executed, cause the processor 202 to be operable to perform dynamic and adaptive rendering of the mixed reality content based on one or more inputs from the camera module 104a in real time. The processor 202 is in communication with the modular mixed reality engine 108, the trigger generation module 206, the detection module 208, the activation module 210, the receiving module 212, the analysing module 214 and the context recognition module 216. Additionally, the processor 202 is in communication with the dynamic orchestrator module 218, the optimization module 220, and the rendering module 222.

The modular mixed reality engine 108 interacts directly with the processor 202, the memory 204, and the camera module 104A to perform real-time computation, rendering, and spatial mapping. The modular mixed reality engine 108 operates as a middleware layer that dynamically identifies, loads, and executes the one or more relevant mixed reality modules based on contextual data and device-specific parameters. In an embodiment of the present disclosure, the modular mixed reality engine 108 enables the real-time synchronization between graphical workloads and sensor inputs through hardware-assisted processing pipelines. The hardware–software integration ensures that computational resources, such as CPU cycles and GPU bandwidth, are adaptively allocated to maintain real-time rendering stability, frame continuity, and spatial alignment between the virtual and the physical elements. The modular mixed reality engine 108 utilizes kernel-level sandboxing mechanisms and context-aware permission management to execute the mixed reality modules 110 securely.

The elements of the computing system 106 collectively work in synchronization to enable the user 102 to access the mixed reality experience. The mixed reality experience is deployed in a distributed computing environment. The distributed computing environment includes a user communication device, a local execution system with a modular mixed reality engine, and a backend server operably coupled with a database. The computing system 106 is executed locally via a transient runtime on the communication device 104 and is configured to selectively render MR content based on metadata and instructions received from the server 114 in response to one or more triggering actions.

The processor 202 executes one or more instructions stored in the memory 204 for enabling the user 102 to access the mixed reality content on the communication device 104.

The trigger generation module 206 is configured to generate a plurality of access triggers. The plurality of access triggers include an image trigger, a URL trigger, a scannable code based trigger (a Quick Response (QR) code), a video trigger, and the like. The trigger generation module 206 generates universal links compatible with any device, regardless of operating system. The trigger generation module 206 generates Uniform Resource Locators (URLs) or Uniform Resource Identifiers (URIs) adhering to standard web protocols. The generated Uniform Resource Locators (URLs) or the Uniform Resource Identifiers (URIs) ensure compatibility across Android, iOS, Windows, and web browsers.

The processor 202 executes an instruction that causes the trigger generation module 206 to trigger the camera module 104a of the communication device 104. The camera module 104a is triggered based on activation of the mixed reality experience. The camera module 104a is triggered by detecting a trigger action of a plurality of triggering actions.

In an embodiment of the present disclosure, the detection module 208 detects the trigger action of the plurality of triggering actions for accessing the mixed reality content at the communication device 104. The plurality of triggering actions correspond to executing or initiating access the mixed reality content via execution of an access trigger of the plurality of access triggers. The plurality of triggering actions includes but may not be limited to scanning a Quick Response (QR) code, clicking a hyperlink, detecting a near field communication (NFC) tag, receiving a voice command, or recognizing a gesture input. In an embodiment of the present disclosure, the Quick Response (QR) code may be captured through one or more cameras of the communication device 104, decoded, and utilized to extract metadata required for initializing the modular mixed reality engine 108.

Each of the plurality of triggering actions serve as a means for the user 102 to initiate access to a mixed reality content using the communication device 104. In an embodiment of the present disclosure, the plurality of triggering actions corresponds to a mode for initiating a device-agnostic and platform-agnostic access to the mixed reality content. The device-agnostic and platform- agnostic access refers to enabling access to the mixed reality content independently of a specific type, make, model, or operating system of the communication device 104. The computing system 106 enables access across a heterogeneous set of user devices, without requiring device-specific configurations or adaptations to enable a hardware or platform independent access to the mixed reality content.

The plurality of triggering actions includes but may not be limited to scanning a Quick Response (QR) code, clicking a hyperlink, detecting a near field communication (NFC) tag, receiving a voice command, or recognizing a gesture input. In an embodiment of the present disclosure, the Quick Response (QR) code may be captured through one or more cameras of the communication device 104, decoded, and utilized to extract metadata required for initializing the modular mixed reality engine 108. In an embodiment of the present disclosure, the scanning of the Quick Response (QR) code includes capturing an image of the Quick Response (QR) code using the camera module 104a of the communication device 104.

In an embodiment of the present disclosure, clicking on the hyperlink received on the communication device 104 facilitates initiating a process of loading metadata linked to the hyperlink for activating the modular mixed reality engine 108. The metadata includes at least one of a mixed reality (MR) experience identifier, asset locations, and one or more parameters controlling the mixed reality (MR) experience. In an embodiment of the present disclosure, detection of the NFC tag through the communication device includes establishing a near-field communication session, retrieving data stored on the NFC tag and utilizing the retrieved data to activate the at least one selected modular mixed reality module.

In an embodiment of the present disclosure, each of the plurality of triggering actions includes a universal access link compatible with the hardware capabilities of the communication device and the environment data. The universal access link includes metadata embedded in at least one of the plurality of triggering actions. Each link contains embedded metadata. The metadata includes at least one of a mixed reality (MR) experience identifier, asset locations, and one or more parameters controlling the mixed reality (MR) experience.

In an embodiment of the present disclosure, the trigger generation module 206 embeds the links into media such as Quick Response (QR) codes, NFC tags, or hyperlinks sent via messaging platforms. For example, a museum uses the module to create Quick Response (QR) codes placed next to exhibits, allowing visitors to scan the codes and instantly access MR experiences related to each exhibit without installing any apps.

The scanning of the Quick Response (QR) code includes capturing an image of the Quick Response (QR) code using the camera module 104a of the communication device 104. Also, scanning of the Quick Response (QR) code further includes decoding of the captured image to extract encoded information and initiate activation of the modular mixed reality engine 108 using the extracted information. Further, clicking on the hyperlink received on the communication device facilitates initiating a process of loading metadata linked to the hyperlink for activating the modular mixed reality engine 108. Also, detection of the NFC tag through the communication device 104 includes establishing a near field communication session, retrieving data stored on the NFC tag, and utilizing the retrieved data to activate the at least one selected modular mixed reality engine 108.

The processor 202 executes an instruction that causes the activation module 210 to initiate the mixed reality experience on the communication device 104 in response to the trigger action. The mixed reality experience is initiated by activating the modular mixed reality engine 108.

The processor 202 executes an instruction that causes the receiving module 212 to receive at least one input of a plurality of inputs in real time from the camera module 104a of the communication device 104. In an embodiment, the at least one input is received as soon as the camera module 104a is triggered. The receiving module 212 receives the at least one input till the mixed reality content is rendered and played on the communication device 104 for continuous and dynamic adaptation of the mixed reality content.

In an embodiment of the present disclosure, the plurality of inputs includes at least one of a spatial positioning data of the communication device 104, an orientation data of the communication device 104, a depth data between the camera module 104a and one or more virtual elements, and one or more optical parameters. The plurality of inputs are received continuously during the mixed reality experience for facilitating the dynamic optimization, adaptive rendering fidelity, and context-aware responsiveness of the mixed reality experience.

In an embodiment of the present disclosure, the depth data is received from the depth sensor of the communication device 104 to dynamically optimize the rendered mixed reality content. The computing system 106 utilizes the depth data to enable one or more of depth-based scaling, occlusion handling, and spatial alignment of the one or more virtual elements with the physical environment.

In an embodiment of the present disclosure, the one or more optical parameters include at least one of a focal length, a zoom type and level, and field of view derived from the camera module. The mixed reality content is dynamically adjusted based on the one or more optical parameters to maintain accurate spatial proportion, visual consistency, and alignment of virtual objects with the physical environment.

In an embodiment of the present disclosure, the method further includes adjusting a scale of a virtual 3D overlay in the rendered mixed reality content based on occurrence and detection of an optical zoom event associated with a lens of the camera module in real time. The scale of the virtual 3D overlay is adjusted such that the virtual 3D overlay align according to a real time zoomed-in perspective of the lens to maintain at least spatial consistency, proportional accuracy and visual coherence between the one or more virtual elements and the physical environment.

The processor 202 executes an instruction that causes the analysing module 214 to analyse the at least one received input of the plurality of inputs to determine one or more spatial characteristics of a physical environment around the communication device 104. The environment refers to the physical environment around the user 102 and the communication device 104. Specifically, the environment refers to a user’s perspective or user’s view visible through the camera module 104a of the communication device 104.

In an embodiment of the present disclosure, the analysing includes determining the one or more spatial characteristics of the physical environment using the at least one input. Next, the analysis includes identifying, based on the at least one input, one or more reference features within the physical environment for anchoring virtual 3D elements. Next, the analysis includes estimating a position and an orientation of the communication device 104 relative to the one or more reference features using motion tracking techniques. Lastly, the analysis includes spatially aligning 3D virtual content with the physical environment based on the position estimation and the one or more spatial characteristics. Accordingly, the analysing module 214 communicates with the rendering module 222 for rendering and displaying the 3D virtual content on the communication device 104.

In an embodiment of the present disclosure, the one or more spatial characteristics includes at least spatial geometry, depth information, surface textures, object boundaries, user viewpoint angle, and relative motion of the communication device with respect to at least one of one or more reference points in the physical environment, previously mapped spatial coordinates, and the rendered one or more virtual elements.

Upon activation of the modular mixed reality engine 108, the processor 202 initiates a context-aware process that enables recognizing a usage context based on hardware capabilities of the communication device 104 and the at least one input in real time. The modular mixed reality (MR) engine 108 enables cross-module communication between at least two dynamically loaded modules of the plurality of mixed reality (MR) modules 110. The cross-module communication facilitates real-time synchronization of at least: 2D and 3D virtual content, rendering states, and user interactions across the plurality of mixed reality (MR) modules 110. The cross-module communication is based on one of a camera input, gesture input, a touch input and contextual data to deliver an immersive and adaptive mixed reality experience.

The processor 202 executes a trigger-based Mixed Reality (MR) activation method for enabling the seamless delivery of the mixed reality content across multiple platforms. The processor 202 is configured to utilize real-time adaptation of 3D content based on input from one or more hardware sensors. Furthermore, the processor 202 employs data optimization techniques, such as content size reduction and integration of edge computing for improved efficiency in data delivery. In an embodiment of the present disclosure, the processor 202 may include a feedback loop mechanism. The feedback loop mechanism enables real-time optimization of the mixed reality experience for significantly improving overall user engagement and interaction.

In an implementation, the computing system 106 interacts with the server 114 and the database 116 to retrieve mixed reality experience metadata, user profiles, and relevant configuration parameters. The computing system 106 dynamically determines at least one mixed reality module of the plurality of mixed reality modules 110 suitable for deployment. Furthermore, the computing system 106 may generate or update a spatial map of physical environment of the user 102, orchestrate adaptive rendering instructions, and transmit an optimized mixed reality content to the communication device 104 in real time. The computing system 106 ensures efficient module delivery, manages runtime execution environments, and helps maintain cross-platform consistency across heterogeneous devices. In an embodiment of the present disclosure, the computing system 106 based on real-time inputs received from the communication device 104. The real-time inputs include at least one of device specifications, environmental context, and user behavior.

Furthermore, the processor 202 executes an instruction that causes the context recognition module 216 to recognize the usage context. The usage context is recognized based on the hardware capabilities of the communication device 104 and the at least one input in real time. In addition, the processor 202 is configured to continuously assess device resource availability based on a set of parameters. The set of parameters includes at least CPU utilization, GPU utilization, battery state, network state and thermal limits. Prior to recognizing the usage context, the processor 202 is configured to capture the usage context based on the data received through the camera module 104a of the communication device 104.

Next, the processor 202 executes an instruction that causes the selection module of the dynamic orchestrator module 218 to select at least one mixed reality (MR) module from the plurality of mixed reality (MR) modules 110. The selection module selects the at least one mixed reality (MR) module based on one or more pre-defined criteria and the usage context. In an embodiment of the present disclosure, the one or more pre-defined criteria include at least one of a type of the communication device 104, the hardware capabilities of the communication device 104, operating system specifications of the communication device 104, types of sensors in the communication device 104, and rendering capacity of the communication device 104. The selection module selects the at least one mixed reality (MR) module for enabling the optimization of the mixed reality content based on the at least one input from the camera module 104a.

In an embodiment of the present disclosure, the plurality of mixed reality (MR) modules 110 includes at least a flat image tracking module, a curved image tracking module, a ground tracking module, and an object tracking module. Each of the plurality of mixed reality (MR) modules 110 is configured to render the mixed reality content on the communication device 104 in real time. Each of the plurality of mixed reality modules 110 is associated with one or more pre-defined functionalities configured for dynamic loading, execution, and unloading based on contextual requirements.

The modular mixed reality engine 108 communicates with the server 114, which acts as a backend orchestration entity. The server 114 is configured to receive and analyze the usage context data from the communication device 104 and select at least one suitable mixed reality module from the plurality of mixed reality (MR) modules 110 for efficient optimization of the mixed reality content using the at least one input. The modular mixed reality engine 108 is configured to communicate with the plurality of mixed reality modules 110, each designed to provide specific MR functionalities. In an example, the flat image tracking module may be utilized to anchor a digital poster onto a flat magazine cover detected through the camera module. In addition, the curved image tracking module may render a label conforming to curvature of a cylindrical bottle. Further, the ground tracking module may place a virtual furniture object on the floor surface. The object tracking module may detect and augment a physical toy car with animated overlays, enabling interaction as the car moves within the camera's field of view.

The processor 202 executes an instruction that causes the loading module of the dynamic orchestrator module 218 to dynamically load the at least one selected mixed reality module. The processor 202 dynamically loads the at least one selected mixed reality module into a secure execution framework. In an embodiment, the secure execution framework corresponds to a kernel-level sandboxed environment executed through an instant application mechanism. The instant application mechanism includes temporarily deploying an instant application on the communication device 104. In an embodiment of the present disclosure, the instant application has a pre-defined size ranging from 900 kilobytes to 1.2 megabytes. The dynamic orchestrator module 218 dynamically loads the at least one mixed reality (MR) module in real-time based on context inferred from the user input and the at least one input, with modules operating within the kernel-level application sandbox in a Linux-based system to ensure both performance and security.

In an embodiment of the present disclosure, the processor 202 is configured to determine whether the selected mixed reality module is to be loaded on the communication device 104 based on evaluating compatibility of the plurality of mixed reality (MR) modules with one or more features of the communication device in real time. The processor 202 determines a selection of a particular module prior to dynamically loading the selected mixed reality (MR) modules into the secure execution framework.

To render the mixed reality content, the processor 202 is further configured to render at least one digital object within the physical environment on a display of the communication device 104 based on the spatial map. The digital object is visually aligned with a real-time camera view captured by the camera module 104a of the communication device 104.

The modular mixed reality engine 108 selects the at least one suitable mixed reality module from the plurality of mixed reality modules 110 based on pre-defined selection criteria and the

derived usage context. The pre-defined selection criteria may include device type, operating system specifications, rendering capability, and sensor availability.

Once selected, the selected mixed reality module(s) are dynamically loaded onto the communication device 104 through an instant application mechanism. The instant application is of a pre-defined size range around 900 kilobytes to 1.2 megabytes. In an embodiment of the present disclosure, the pre-defined size range of the instant application may vary. The instant application provides temporary execution without requiring installation, thus enabling efficient and scalable deployment across heterogeneous device environments. For instance, in a city navigation MR app, when a user points their device at a landmark, the computing system 106 dynamically loads the module responsible for overlaying historical information. As the user moves away, this module is unloaded, and a module for general navigation is loaded instead.

Upon successful deployment, the selected mixed reality module renders the mixed reality content in real time on the communication device 104. To render, the selected mixed reality module may perform placement of digital objects within the user’s physical environment based on a spatial map generated from camera input captured from the one or more cameras of the communication device 104. The spatial map of the physical environment is generated by applying computer vision algorithms on the camera input. The spatial map of the physical environment represents surfaces, objects, and the user context. The spatial map is continuously updated in real-time. The rendered MR content may include alpha channel video overlays, interactive 3D objects, or other visual elements aligned with the device’s real-time camera feed. The alpha channel video overlays are responsive to various user inputs, including touch, voice, motion, gaze, and gestures.

The processor 202 executes an instruction that causes the optimization module 220 to dynamically and adaptively optimize one or more virtual elements associated with the mixed reality content in real time. The optimization module 220 optimizes the mixed reality content based on a pre-defined threshold change in the at least one received input of the plurality of inputs from the camera module 104a of the communication device 104. The optimization enables spatial coherence between the one or more virtual elements associated with the mixed reality content and the corresponding physical environment captured through the camera module 104a.

In an embodiment of the present disclosure, the pre-defined threshold change in the received at least one input of the plurality of inputs includes a variation in at least one of a spatial position, an orientation, depth data exceeding a pre-defined value and one or more optical parameters. The dynamic and iterative optimization of the mixed reality content is triggered upon detection of the variation to minimize recalculations and ensure rendering efficiency.

In an embodiment of the present disclosure, the dynamic optimization is done based on a combination of a depth data received from a depth sensor of the communication device 104 and the at least one input of the plurality of inputs received from a camera sensor of the communication device 104.

In an embodiment of the present disclosure, dynamically optimizing the mixed reality content includes adjusting positions of the one or more virtual elements in real time based on the at least one input related to change in spatial positioning, scaling, depth alignment, or occlusion handling based on the user’s real-time viewpoint.

The processor 202 executes an instruction that causes the rendering module 222 to render the dynamically optimized mixed reality content based on the pre-defined threshold change. The mixed reality content is rendered using the at least one mixed reality module of the plurality of mixed reality modules 110. The dynamically optimized mixed reality content includes at least the one or more virtual elements anchored in accordance with at least a spatial position and orientation of the communication device 104.

In an embodiment, the rendering module 222 renders the mixed reality content in real time on the communication device 104 using the at least one selected mixed reality module. The at least one selected mixed reality module enables efficient optimization of the mixed reality content based on the real time input data. The rendering is done by deploying the secure execution framework on the communication device 104. In an embodiment of the present disclosure, the secure execution framework corresponds to an instant application executed within a transient runtime environment on the communication device 104. The mixed reality content is rendered on the communication device 104 in real time through the kernel-level sandboxed environment.

In an embodiment of the present disclosure, the alpha channel video overlays allow a transparent video to be superimposed on the real-world view captured by a camera module of the communication device 104. The alpha channel video overlay may be used to add virtual elements to the environment or enhance existing features. Key features include transparency support, utilizing videos with an alpha channel to render transparent or semi-transparent overlays, real-time rendering, where overlays are adjusted to the camera's perspective and movement, and virtual element integration, allowing overlays to represent virtual objects, characters, or informational content that seamlessly blend with the real world. For instance, in an MR shopping app, a user can see how a piece of furniture would look in their room by viewing a transparent 3D model overlaid on their camera feed, or by viewing an experience for an advertisement in a newspaper.

In an embodiment of the present disclosure, the processor 202 further performs motion tracking to determine the movement pattern of the user 102 in relation to the physical environment by capturing the sequence of images of the physical environment, analyzing the one or more changes in visual features across consecutive frames to determine translational and rotational movement of the communication device 104 and enabling, based on the analysis, synchronized transitions and responsive adaptation of the mixed reality content in accordance with the motion of the user 102.

In an embodiment of the present disclosure, the modular mixed reality engine 108 enables cross-module communication. In an example, the cross-module communication facilitates real-time data exchange between the plurality of mixed reality modules 110, ensuring seamless interaction between 2D alpha content and 3D environment mapping.

Furthermore, the MR content is anchored persistently within the physical environment such that digital objects maintain their spatial orientation and positioning even as the communication device 104 moves, thereby providing a consistent and immersive MR experience. The digital object is visually aligned with a real-time camera view captured by the one or more cameras of the communication device 104.

To enhance security and performance, the plurality of mixed reality modules 110 are executed within a secure sandboxed environment at a kernel level of a Linux-based operating system of the communication device 104. The computing system 106 is further configured to enable seamless playback of the rendered MR content on the communication device 104. The seamless playback is achieved through a continuous optimization of the mixed reality content based on the at least one input.

In an embodiment of the present disclosure, the plurality of mixed reality modules 110 execute in a secure and efficient sandbox at the kernel level on a Linux-based system. The isolated and lightweight execution environment allows fast context-switching between the plurality of mixed reality modules 110. In addition, the switching prevents performance degradation, and contributes to smooth playback.

The processor 202 is configured to receive an image stabilization feedback (herein after feedback) from at least one of an optical image stabilization (OIS) or electronic image stabilization (EIS) system of the camera module 104. The image stabilization feedback is utilized to maintain accurate anchoring and reduce jitter of the rendered mixed reality content during movement of the communication device 104.

For example, when rendering a virtual sculpture in a user's living room, the processor 202 receives real-time depth data from a depth sensor of the communication device 104 along with spatial input from the camera module 104a. Based on this data, the processor 202 dynamically scales the virtual sculpture to maintain realistic proportions relative to nearby furniture, aligns the sculpture to rest accurately on the detected floor surface, and ensures occlusion handling such that the sculpture appears partially hidden behind a physical table when viewed from certain angles. The processor 202 continuously updates the sculpture’s spatial placement and visibility based on changes in the user’s real-time viewpoint, thereby enhancing the realism and coherence of the mixed reality (MR) experience.

The processor 202 is configured to adjust the one or more transparent video overlays in real time based on at least a real time data from the camera module 104a and real time user movement data. The adjustment is done based on spatial alignment of the one or more virtual elements and the environment.

The processor 202 and the memory 204 cooperate with the camera module 104a, to dynamically manage computational and graphical workloads. The cooperation reduces frame lag, improves spatial coherence, and enhances device-level rendering efficiency during the real-time mixed reality display.

The processor 202 allocates memory resources in real time based on frame complexity, sensor input density, and rendering priority. The memory 204 corresponds to a non-transitory memory. In an embodiment of the present disclosure, the non-transitory memory is configured to store one or more executable instructions, data structures, and program modules. The instructions are executed by the processor 202, to cause the computing system 106 to perform one or more of the functions described herein. The non-transitory memory includes, but is not limited to, a persistent storage medium such as a hard disk drive, flash memory, solid-state storage, read-only memory (ROM), or other physical storage devices. The non-transitory nature of the memory 204 ensures that the stored program instructions remain persistently available to the processor 202, for enabling consistent execution of system-level operations. In operation, the memory 204 stores machine-executable instructions that facilitate the real-time activation of the modular mixed reality engine 108, the dynamic loading of the plurality of mixed reality modules 110, adaptive resource management, and the real-time rendering of mixed reality (MR) content on the communication device 104.

The memory 204 temporarily stores intermediate frame buffers, depth maps, and texture assets. Accordingly, the processor 202 fetches, processes, and renders the frames without latency caused by repeated data retrieval. The real-time coordination ensures that high-priority operations such as the motion tracking and the object placement are executed without performance degradation. The cooperation between the hardware components enables adaptive workload balancing. When the camera module 104a captures scenes with high motion or dense geometry, the processor 202 offloads certain image processing operations to the GPU or dedicated hardware accelerators. The memory 204 subsystem reallocates bandwidth to support rapid read–write operations, and the processor 202 adjusts thread scheduling to maintain consistent frame output.

The hardware-level balancing mechanism reduces system strain during peak processing loads, preventing frame drops and rendering stalls. As a result, the cooperative interaction between the processor 202, the memory 204, and the camera module 104a reduces perceptible frame lag and improves the spatial coherence between the virtual and the real-world elements. The synchronization of data flow among the components ensures that the rendered objects maintain accurate positioning even under rapid device movement.

In an embodiment of the present disclosure, the processor 202, the memory 204, the camera module 104A, and the modular mixed reality engine 108 cooperate at the hardware level to achieve enhanced computational efficiency and graphical performance. The processor 202 executes instructions retrieved from the non-transitory memory (the memory 204) to process real-time input data acquired through the camera module 104A. The modular mixed reality engine 108 dynamically coordinates the execution of the one or more relevant mixed reality modules. The interaction among these hardware components ensures optimized task scheduling, adaptive memory allocation, and efficient data exchange between processing and rendering subsystems. The hardware-level cooperation facilitates low-latency data throughput, stable frame rendering, and accurate spatial alignment between the virtual and the physical environments.

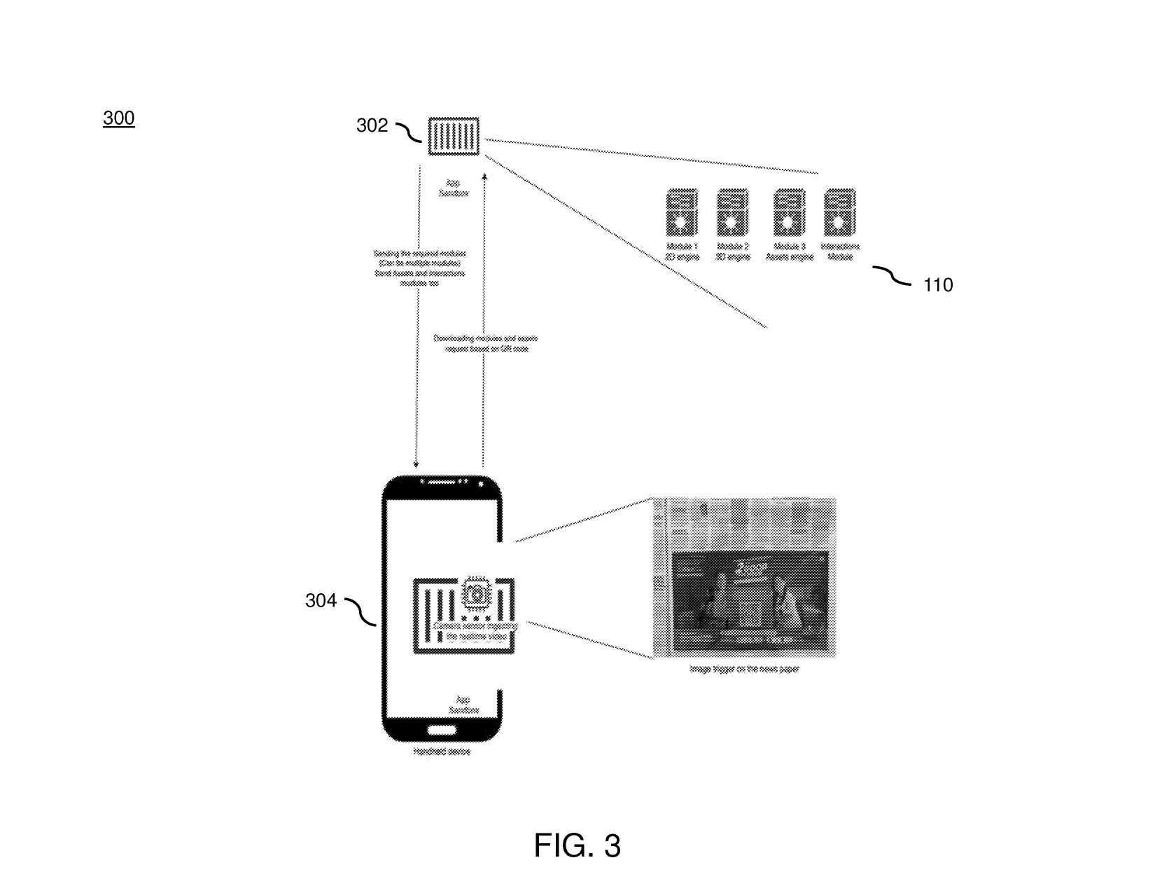

FIG. 3 illustrates an exemplary environment 300 for downloading of a sandbox at run time without downloading an instant application, in accordance with an embodiment of the present disclosure. The application sandbox is downloaded for rendering the mixed reality content. The mixed reality content is optimized on the basis of the real-time input data from the camera module 104a. The exemplary environment 300 enables trigger-based instantiation and modular deployment of mixed reality content on a handheld device 304. As shown, the environment 300 includes the handheld device 304 executing within an application sandbox environment. The handheld device 304 may be a smartphone, a tablet, or a wearable computing device. The handheld device 304 includes a camera sensor configured to capture real-time video frames of a physical environment. In the depicted embodiment, a physical medium, such as a printed newspaper, includes an image trigger, for example, a Quick Response (QR) code, bar code, visual glyph, or any computer-vision-recognizable pattern.

Upon ingestion of the image trigger through the camera sensor, the application executing within the sandbox parses and identifies the trigger for initiating a content request to the remote app sandbox server 302. The request includes a module and asset retrieval directive based on the specific image trigger identified.

The app sandbox server 302 orchestrates the retrieval and transmission of one or more modular engines and associated assets to the handheld device 304. In an example, the server 114 represented as the app sandbox server 302 and the communication device 104 is represented as the handheld device 304. As illustrated, the app sandbox server 302 may include a plurality of modular engines, including but not limited to module 1 (2D engine), module 2 (3D engine), module 3 (assets engine), and interactions module. The module 1 is configured to process and render two-dimensional content layers in the MR environment. The module 2 is configured to process and render three-dimensional spatial content. The module 3 is configured to retrieve, manage, and serve graphical assets, such as textures, meshes, audio files, and animation sequences. The interactions module is configured to enable and manage user interaction mechanisms, such as gesture-based input, touch input, gaze detection, or voice input, in coordination with rendered content.

Following transmission, the handheld device 304 dynamically loads and executes the received modules and assets within the device’s sandboxed runtime environment.

The exemplary environment 300 allows for selective instantiation of only the components required for a given trigger context, thereby reducing computational overhead, memory usage, and network bandwidth consumption.

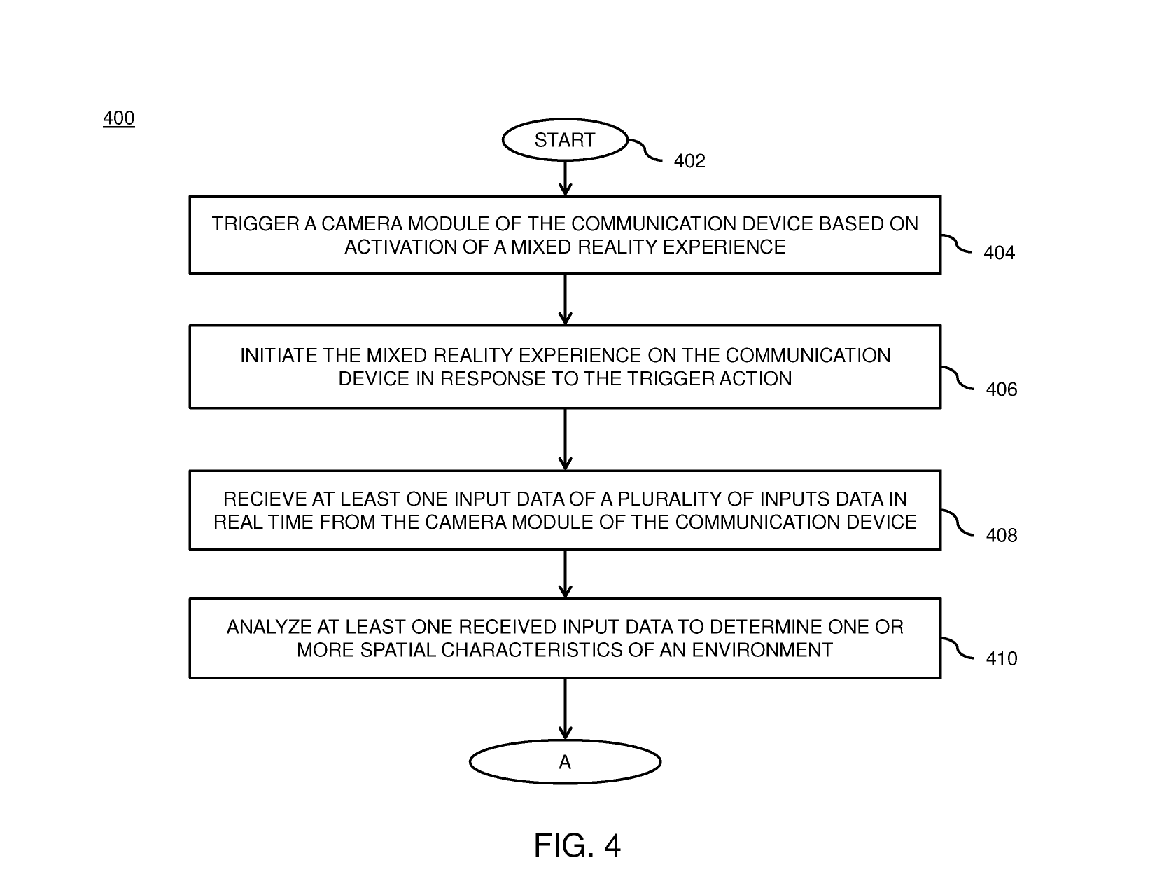

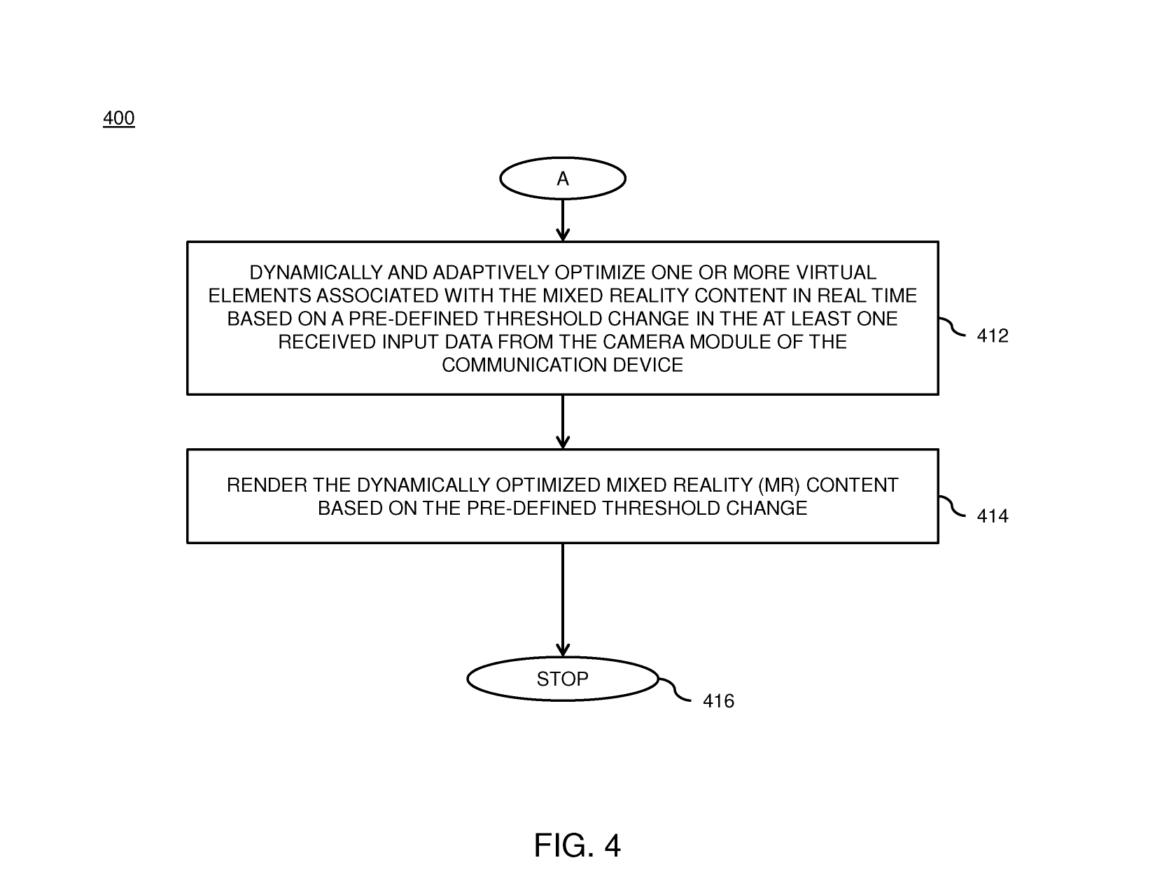

FIG. 4 illustrates a flowchart 400 of a computer-implemented method for dynamic and adaptive mixed reality content display at the communication device 104, in accordance with various embodiments of the present disclosure. It may be noted that the description of the flowchart 400 refers to FIG. 1, and FIG. 2. The working and functioning may be read from the description of FIG. 1, and FIG. 2.

The flowchart 400 initiates at step 402. At step 404, the method includes triggering the camera module 104a of the communication device 104 based on the activation of the mixed reality experience. The camera module 104a is triggered by detecting the trigger action of the plurality of triggering actions.

In an embodiment of the present disclosure, the plurality of triggering actions corresponds to a mode for initiating a device-agnostic access to the mixed reality content. The plurality of triggering actions includes at least scanning of a Quick Response (QR) code through a camera module of the communication device, clicking on a hyperlink received on the communication device, and detection of a near field communication (NFC) tag through the communication device 104.

At step 406, the method includes initiating the mixed reality experience on the communication device 104 in response to the trigger action.

At step 408, the method includes receiving at least one input of a plurality of inputs in real time from the camera module 104a of the communication device 104 during rendering of the mixed reality content.

In an embodiment of the present disclosure, the plurality of inputs includes at least one of the spatial positioning data of the communication device 104, an orientation data of the communication device 104, the depth data between the camera module 104a and the one or more virtual elements, and the one or more optical parameters. The plurality of inputs are received continuously during the mixed reality experience for facilitating the dynamic optimization, adaptive rendering fidelity, and context-aware responsiveness of the mixed reality experience.

In an embodiment of the present disclosure, the depth data is received from the depth sensor of the communication device 104 to dynamically optimize the rendered mixed reality content by enabling one or more of depth-based scaling, occlusion handling, and spatial alignment of the one or more virtual elements with the physical environment.

At step 410, the method includes analyzing the at least one received input of the plurality of inputs to determine the one or more spatial characteristics of a physical environment around the communication device 104.

In an embodiment of the present disclosure, the analysing includes determining the one or more spatial characteristics of the physical environment using the at least one input, identifying, based on the at least one input, one or more reference features within the physical environment for anchoring virtual 3D elements, estimating position and orientation of the communication device 104 relative to the one or more reference features using the motion tracking techniques and rendering and displaying 3D virtual content that is spatially aligned with the physical environment based on the position estimation and the one or more spatial characteristics.

In an embodiment of the present disclosure, the one or more spatial characteristics includes at least spatial geometry, depth information, surface textures, object boundaries, user viewpoint angle, and relative motion of the communication device 104 with respect to at least one of one or more reference points in the physical environment, previously mapped spatial coordinates, and the rendered one or more virtual elements.

At step 412, the method includes dynamically and adaptively optimizing the one or more virtual elements associated with the mixed reality content in real time based on the pre-defined threshold change in the at least one received input of the plurality of inputs from the camera module 104a of the communication device 104. The optimization enables the spatial coherence between the one or more virtual elements associated with the mixed reality content and the corresponding physical environment captured through the camera module 104a.

In an embodiment of the present disclosure, the pre-defined threshold change in the received at least one input of a plurality of inputs includes the variation in at least one of a spatial position, the orientation, the depth data exceeding a pre-defined value and one or more optical parameters. The dynamic and iterative optimization of the mixed reality content is triggered upon detection of the variation to minimize recalculations and ensure rendering efficiency.

In an embodiment of the present disclosure, the one or more optical parameters include at least one of a focal length, a zoom type and level, and field of view derived from the camera module 104a. The mixed reality content is dynamically adjusted based on the one or more optical parameters to maintain accurate spatial proportion, visual consistency, and alignment of virtual objects with the physical environment.

In an embodiment of the present disclosure, the dynamic optimization is done based on the combination of the depth data received from the depth sensor of the communication device 104 and the at least one input of the plurality of inputs received from the camera sensor of the communication device 104.

In an embodiment of the present disclosure, dynamically optimizing the mixed reality content includes adjusting positions of the one or more virtual elements in real time based on the at least one input related to change in spatial positioning, scaling, depth alignment, or occlusion handling based on the user’s real-time viewpoint.

At step 414, the method includes rendering the dynamically optimized mixed reality content based on the pre-defined threshold change. The mixed reality content is rendered using the at least one mixed reality module of the plurality of mixed reality modules 110. The dynamically optimized mixed reality content includes at least the one or more virtual elements anchored in accordance with at least the spatial position and orientation of the communication device 104.

In an embodiment of the present disclosure, the rendering of the mixed reality content on the communication device 104 includes the recognition of the usage context based on hardware capabilities of the communication device 104 and the at least one input in real time. Next, the rendering includes identification of the at least one mixed reality (MR) module from the plurality of mixed reality modules 110 based on the usage context recognition in real time. Lastly, the rendering includes the dynamic loading of the at least one identified mixed reality module within the secure execution framework. The at least one identified mixed reality module is configured to render the mixed reality content.

In an embodiment of the present disclosure, the method further includes adjusting the scale of the virtual 3D overlay in the rendered mixed reality content based on occurrence and detection of an optical zoom event associated with a lens of the camera module 104a in real time. The scale of the virtual 3D overlay is adjusted such that the virtual 3D overlay align according to the real time zoomed-in perspective of the lens to maintain at least spatial consistency, proportional accuracy and visual coherence between the one or more virtual elements and the physical environment.

In an embodiment of the present disclosure, the method further includes receiving the image stabilization feedback from at least one of the optical image stabilization (OIS) or electronic image stabilization (EIS) system of the camera module 104a. The image stabilization feedback is utilized to maintain accurate anchoring and reduce jitter of the rendered mixed reality content during movement of the communication device 104.

In an embodiment of the present disclosure, the method further includes performing motion tracking to determine the movement pattern of the user 102 in relation to the physical environment by capturing the sequence of images of the physical environment, analyzing the one or more changes in visual features across consecutive frames to determine translational and rotational movement of the communication device 104 and enabling, based on the analysis, synchronized transitions and responsive adaptation of the mixed reality content in accordance with the motion of the user 102.

The dynamic optimization and the rendering are performed through hardware-level cooperation between a processor associated with the communication device 104, display unit, and the camera module 104a. The hardware-level cooperation improves real-time frame stability, reduces rendering latency, and enhances spatial alignment accuracy during the mixed reality content display. The processor 202 executes a series of rendering instructions that directly interface with the camera module’s 104a input stream and the display pipeline. The cooperation enables the computing system 106 to analyze the real-time image frames captured by the camera module 104a, extract the depth and the motion data, and instantly adjust the rendering parameters. In an embodiment, the rendering parameters include the object scaling, and the orientation to maintain high spatial fidelity. The processor 202 and the camera module 104a operate in a feedback loop. Each processed frame informs the subsequent rendering cycle for maintaining a consistent spatial alignment between physical and virtual objects. In the cooperative arrangement, the display unit functions as an output device as well as a synchronized rendering surface updated through adaptive frame timing controlled by the processor 202. The synchronization between the display refresh cycles and the incoming sensor data stream prevents frame tearing and jitter, leading to smoother visual transitions during motion. Further, the hardware-level cooperation leverages a graphics processing unit (GPU) embedded within the communication device 104 to distribute computational tasks efficiently, to reduce CPU load and improve overall responsiveness. Through the hardware-level interplay, the computing system 106 achieves significant performance improvements. The cooperation enhances real-time frame stability by maintaining consistent refresh synchronization between the display and the camera module 104a, reduces rendering latency by minimizing data transfer bottlenecks, and ensures precise spatial alignment of the virtual elements. The cooperation results in an immersive and stable mixed reality experience that remains responsive to both device motion and environmental changes without perceptible lag.

The flowchart 400 terminates or ends at step 416.

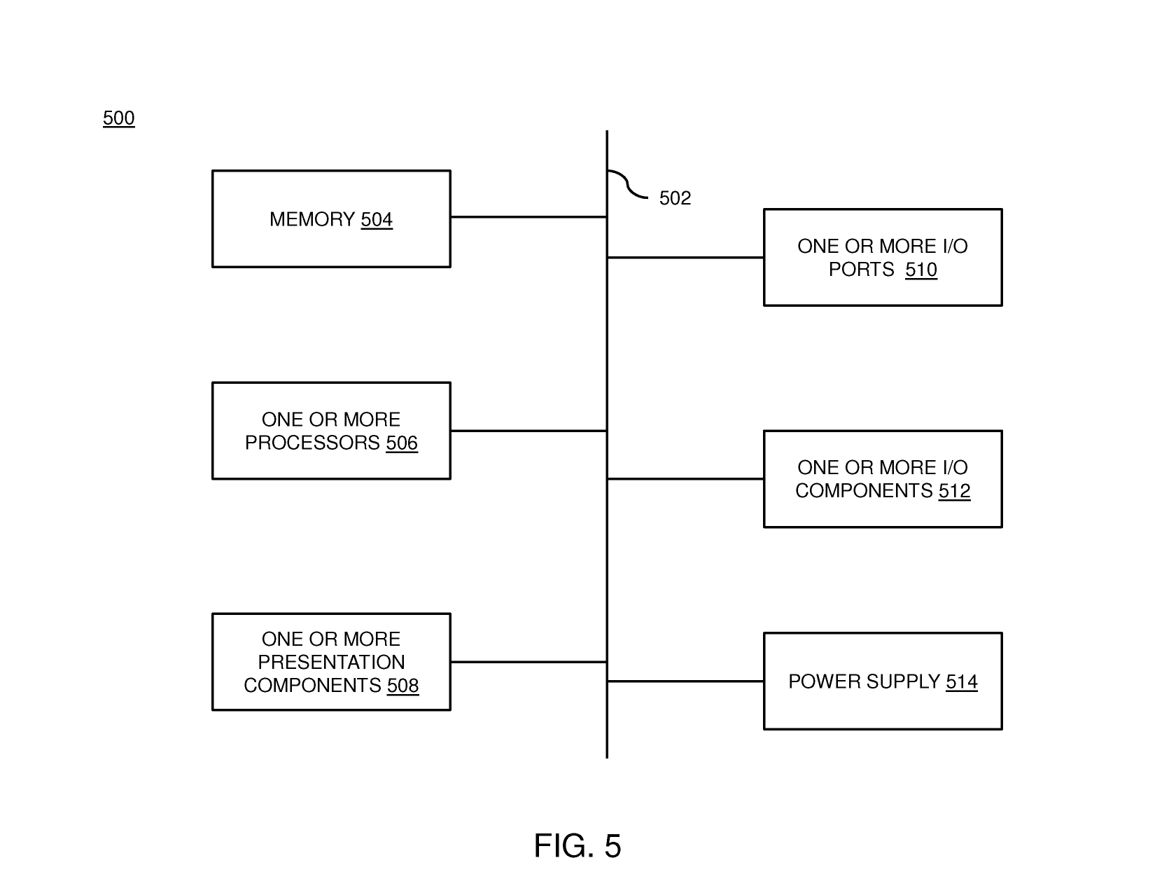

FIG. 5 illustrates a block diagram of an exemplary computing device 500 executing the rendering of the mixed reality content, in accordance with various embodiments of the present disclosure. The computing device 500 includes a bus 502 that directly or indirectly couples the following devices: memory 504, the one or more processors 506, one or more presentation components 508, one or more input/output (I/O) ports 510, one or more input/output components 512, and an illustrative power supply 514. The bus 502 represents what may be one or more buses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art and reiterate that the diagram of FIG. 5 is merely illustrative of the exemplary computing device 500 that can be used in connection with one or more embodiments of the present disclosure. Distinction is not made between such categories as “workstation,” “server,” “laptop,” “hand-held device,” etc., as all are contemplated within the scope of FIG. 5 and reference to “device.”

In an embodiment of the present disclosure, the computing device 500 corresponds to a non-transitory computer-readable storage medium. The non-transitory computer-readable storage medium corresponds to a tangible hardware element configured to store the computer-executable instructions. The one or more processors 506 execute the stored instructions to cause the computing system 106 to perform operations associated with the dynamic mixed reality content rendering, the adaptive resource allocation, and the real-time spatial synchronization. The non-transitory nature of the computer-readable medium distinguishes the medium from transitory signal forms such as carrier waves or propagated signals. In addition, the non-transitory nature ensures that the instructions are implemented on a physical computing apparatus. Accordingly, the medium provides a hardware-based realization of the computer-implemented method, contributing to reduced latency, improved frame stability, and enhanced rendering performance.

The non-transitory nature of the computing device 500 signifies that the storage medium is physically embodied and does not include transitory signal media, such as carrier waves or propagated signals. Examples of such non-transitory storage media include, but are not limited to, solid-state drives (SSDs), flash memory, magnetic disks, optical disks, or read-only memory (ROM). Furthermore, the computing device 500 stores machine-level instructions configured to cause at least one processor to execute the real-time data acquisition from the camera module 104a, process the sensor input, dynamically load the at least one mixed reality module, and render the spatially coherent mixed reality (MR) content. The hardware-tied execution of the instructions ensures improved real-time responsiveness, optimized resource utilization, and enhanced rendering performance.

The computing device 500 typically includes a variety of computer-readable media. The computer-readable media can be any available media that can be accessed by the computing device 500 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 500. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct- wired connection, and wireless media such as acoustic, RF, infrared and other wireless media. Combinations of any of the above should also be included within the scope of computer-readable media.

The memory 504 includes computer-storage media in the form of volatile and/or nonvolatile memory. The memory 504 may be removable, non-removable, or a combination thereof. Exemplary hardware devices include solid-state memory, hard drives, optical-disc drives, etc. The computing device 500 includes the one or more processors 506 that read data from various entities such as the memory 504 or the one or more I/O components 512. The one or more presentation components 508 present data indications to a user or other device. Exemplary presentation components include a display device, speaker, printing component, vibrating component, etc. The one or more I/O ports 510 allow the computing device 500 to be logically coupled to other devices including the one or more I/O components 512, some of which may be built in. Illustrative components include a microphone, joystick, game pad, satellite dish, scanner, printer, wireless device, etc.

The execution of the instructions causes hardware-level adaptation of rendering parameters of the communication device 104. The hardware-level adaptation enables optimized synchronization between the one or more processors and the camera module 104a. In addition, the hardware-level adaptation reduces computational overhead during the real-time mixed reality rendering. The adaptation dynamically modifies variables such as frame rate, resolution scaling, and occlusion thresholds based on the feedback received from the camera module 104a. The processor 202 interprets the real-time spatial and the motion data captured by the camera and accordingly fine-tunes the rendering parameters to maintain perceptual consistency and display performance. The hardware-level adaptation enables the modular mixed reality engine 108 to operate efficiently under varying device motion, and sensor input conditions. The adaptive mechanism establishes a direct synchronization pathway between the processor 202 and the camera module 104a. The synchronization ensures that camera-captured frames and rendered overlays are temporally aligned to a sub-frame precision level, preventing visual discrepancies such as motion blur or ghosting of virtual objects. The processor 202 adjusts internal buffer timing and rendering cycles based on camera capture intervals. As a result, the processor 202 ensures that the displayed mixed reality content is updated synchronously with the communication device’s 104 physical motion. In addition, the hardware-level adaptation substantially reduces computational overhead during the real-time mixed reality rendering. By continuously optimizing the rendering parameters in response to the sensor feedback, the computing system 106 avoids redundant processing cycles and unnecessary resource allocation. The continuous optimization leads to improved power efficiency and sustained device performance during prolonged usage. Consequently, the adaptive coordination between processing, sensing, and rendering components results in low-latency, high-accuracy visualization. The adaptive coordination mechanism enhances the realism and continuity of the mixed reality experience across different device configurations and environmental contexts.

In an embodiment of the present disclosure, execution of the computer-executable instructions by the one or more processors improves operation of the communication device 104 by reducing computational cycles required for real-time rendering of the one or more virtual elements and performing the adaptive resource allocation. The adaptive resource allocation includes adjusting the rendering fidelity and computational priority based on a real-time assessment of the hardware capabilities of the communication device 104. The dynamic balancing enhances system latency, ensures smoother transitions between frames, and maintains consistent visual stability even under constrained device resources.

In another embodiment, the hardware-level cooperation between the processor 202, the memory 204, the display hardware, and the camera module 104a enables concurrent processing of the sensor inputs and the rendering workloads. Such parallelized execution improves data throughput efficiency, reduces latency in spatial updates, and enhances synchronization accuracy between the real and virtual environments. As a result, the mixed reality system achieves tangible technical benefits, including reduced frame lag, optimized memory usage, and improved responsiveness during interactive user sessions.

The present disclosure is described hereinafter by various embodiments. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of system architectures are identified as suitable for various facets of the implementations. These system architectures are to be treated as exemplary and are not intended to limit the scope of the invention.

The foregoing descriptions of specific embodiments of the present technology have been presented for the purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the disclosure have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computing system for dynamic and adaptive mixed reality content display, the computing system comprising:
one or more processors; and
a non-transitory memory storing computer-executable instructions that, when executed, cause the one or more processors to:
trigger a camera module of a communication device based on activation of a mixed reality experience, wherein the camera module is triggered by detecting a trigger action of a plurality of triggering actions;
initiate the mixed reality experience on the communication device in response to the trigger action;
receive, in real time, at least one input of a plurality of inputs from the camera module of the communication device;
analyze the received at least one input of the plurality of inputs to determine one or more spatial characteristics of a physical environment surrounding the communication device;
dynamically and adaptively optimize one or more virtual elements associated with the mixed reality content in real time based on a pre-defined threshold change in the received at least one input of the plurality of inputs, wherein the optimization enables spatial coherence between the one or more virtual elements and the corresponding physical environment captured through the camera module; and
render the dynamically optimized mixed reality content based on the pre-defined threshold change, wherein the mixed reality content is rendered using at least one mixed reality module of a plurality of mixed reality modules, and wherein the dynamically optimized mixed reality content comprises the one or more virtual elements anchored in accordance with at least a spatial position and orientation of the communication device,
wherein the one or more processors and the non-transitory memory cooperate with the camera module and display hardware of the communication device to dynamically manage computational and graphical workloads to improve frame stability, and reduce latency through adaptive hardware-level synchronization during the real-time mixed reality content rendering.

2. The computing system of claim 1, wherein the instructions, when executed, cause the one or more processors to render the mixed reality content on the communication device based on
recognizing a usage context associated with hardware capabilities of the communication device and the at least one input in real time;
identifying at least one mixed reality (MR) module from a plurality of mixed reality modules of a modular mixed reality engine based on the usage context recognition in real time; and
dynamically loading the at least one identified mixed reality module within a secure execution framework, wherein the at least one identified mixed reality module is configured to render the mixed reality content.

3. The computing system of claim 1, wherein the plurality of triggering actions corresponds to a mode for initiating a device-agnostic and platform-agnostic access to the mixed reality content, wherein the plurality of triggering actions comprises at least
scanning of a Quick Response (QR) code through the camera module of the communication device;
clicking on a hyperlink received on the communication device; and
detection of a near-field communication (NFC) tag through the communication device.

4. The computing system of claim 1, wherein the plurality of inputs comprise at least one of spatial positioning data of the communication device, orientation data of the communication device, depth data between the camera module and the one or more virtual elements, and one or more optical parameters, wherein the plurality of inputs are received continuously during the mixed reality experience for facilitating dynamic optimization, adaptive rendering fidelity, and context-aware responsiveness.

5. The computing system of claim 4, wherein the one or more processors dynamically optimize the rendered mixed reality content based on depth data received from a depth sensor of the communication device, wherein the rendered mixed reality content is optimized to perform at least one of depth-based scaling, occlusion handling, and spatial alignment of the one or more virtual elements with the physical environment.

6. The computing system of claim 1, wherein the one or more processors are configured to analyze the at least one input by:
determining one or more spatial characteristics of the physical environment using the at least one input;
identifying, based on the at least one input, one or more reference features within the physical environment for anchoring the one or more virtual elements;
estimating a position and orientation of the communication device relative to the one or more reference features using motion tracking techniques; and
enabling spatial alignment of the one or more virtual elements with the physical environment based on the position estimation and the one or more spatial characteristics.

7. The computing system of claim 6, wherein the one or more spatial characteristics comprise at least spatial geometry, depth information, surface textures, object boundaries, user viewpoint angle, and relative motion of the communication device with respect to one or more reference points in the physical environment, previously mapped spatial coordinates, or the rendered one or more virtual elements.

8. The computing system of claim 1, wherein the one or more processors are configured to trigger dynamic and iterative optimization of the mixed reality content upon detecting a pre-defined threshold variation in at least one of spatial position, orientation, depth data, or optical parameters, to minimize recalculations and ensure real-time rendering efficiency.

9. The computing system of claim 1, wherein the one or more processors dynamically optimize the mixed reality content based on a combination of depth data received from a depth sensor of the communication device and image data received from a camera sensor of the communication device.

10. The computing system of claim 1, wherein the one or more processors dynamically adjust positions of the one or more virtual elements in real time based on the at least one input related to changes in spatial positioning, scaling, depth alignment, or occlusion handling in accordance with a user’s real-time viewpoint.

11. The computing system of claim 1, wherein the one or more processors are configured to perform motion tracking to determine a movement pattern of a user relative to the physical environment by:
capturing a sequence of images of the physical environment;
analyzing changes in visual features across consecutive frames to determine translational and rotational movement of the communication device; and
enabling, based on the analyzing, synchronized transitions and responsive adaptation of the mixed reality content according to the detected movement.

12. The computing system of claim 1, wherein the one or more processors dynamically adjust the mixed reality content based on one or more optical parameters derived from the camera module, wherein the one or more optical parameters comprise at least one of focal length, zoom type, zoom level, and field of view, to maintain spatial proportion, visual consistency, and alignment of virtual objects with the physical environment.

13. The computing system of claim 1, wherein the one or more processors adjust a scale of a virtual 3D overlay in the rendered mixed reality content based on detection of an optical zoom event associated with a lens of the camera module in real time, wherein the scale adjustment aligns the virtual 3D overlay with a zoomed-in perspective of the lens to maintain spatial consistency and proportional accuracy between the one or more virtual elements and the physical environment.

14. The computing system of claim 1, wherein the one or more processors utilize image stabilization feedback from at least one of an optical image stabilization (OIS) or electronic image stabilization (EIS) system of the camera module to maintain accurate anchoring and reduce jitter of the rendered mixed reality content during movement of the communication device.

15. A computer-implemented method executed by one or more processors of a computing system for dynamic and adaptive mixed reality (MR) content display, the method comprising:
triggering a camera module of a communication device based on activation of a mixed reality experience, wherein the camera module is triggered by detecting a trigger action of a plurality of triggering actions;
initiating the mixed reality experience on the communication device in response to the trigger action;
receiving, in real time, at least one input of a plurality of inputs from the camera module of the communication device;
analyzing the received at least one input of the plurality of inputs to determine one or more spatial characteristics of a physical environment surrounding the communication device;
dynamically and adaptively optimizing one or more virtual elements associated with the mixed reality content in real time based on a pre-defined threshold change in the received at least one input of the plurality of inputs, wherein the optimization enables spatial coherence between the one or more virtual elements and the corresponding physical environment captured through the camera module; and
rendering the dynamically optimized mixed reality content based on the pre-defined threshold change, wherein the mixed reality content is rendered using at least one mixed reality module of a plurality of mixed reality modules, and wherein the dynamically optimized mixed reality content comprises the one or more virtual elements anchored in accordance with at least a spatial position and orientation of the communication device,
wherein execution of the computer-executable instructions by the one or more processors causes improvement in operation of the communication device by enabling hardware-level coordination between the one or more processors, a memory, display hardware, and the camera module for adaptive rendering control, reducing redundant computation cycles, lowering real-time latency, and maintaining spatial alignment accuracy during the mixed reality content display.

16. The computer-implemented method of claim 15, wherein the plurality of inputs comprise at least one of a spatial positioning data of the communication device, an orientation data of the communication device, a depth data between the camera module and the one or more virtual elements, and one or more optical parameters, wherein the plurality of inputs are received continuously during the mixed reality experience to facilitate dynamic optimization, adaptive rendering fidelity, and context-aware responsiveness of the mixed reality experience.

17. The computer-implemented method of claim 15, wherein the analyzing of the one or more received input data comprises:
determining one or more spatial characteristics of the physical environment using the at least one received input;
identifying, based on the one or more received input data, one or more reference features within the physical environment for anchoring the one or more virtual elements;
estimating a position and orientation of the communication device relative to the one or more reference features using motion tracking techniques; and
enabling spatial alignment of the one or more virtual elements with the physical environment based on the estimated position and the determined one or more spatial characteristics.

18. The computer-implemented method of claim 17, wherein the one or more spatial characteristics comprise at least spatial geometry, depth information, surface textures, object boundaries, user viewpoint angle, and relative motion of the communication device with respect to at least one of one or more reference points in the physical environment, previously mapped spatial coordinates, and the rendered one or more virtual elements.

19. The computer-implemented method of claim 15, wherein the pre-defined threshold change in the at least one received input comprises a variation in at least one of a spatial position, orientation, or depth data exceeding a pre-defined value, or one or more optical parameters, and wherein the dynamic and iterative optimization of the mixed reality content is triggered upon detection of the variation to minimize recalculations and ensure rendering efficiency.

20. A non-transitory computer-readable storage medium storing computer-executable instructions which, when executed by one or more processors of a computing device, cause the computing device to perform a method for dynamic and adaptive mixed reality content display, the method comprising:
triggering a camera module of a communication device based on activation of a mixed reality experience, wherein the camera module is triggered by detecting a trigger action of a plurality of triggering actions;
initiating the mixed reality experience on the communication device in response to the trigger action;
receiving, in real time, at least one input of a plurality of inputs from the camera module of the communication device;
analyzing the received at least one input of the plurality of inputs to determine one or more spatial characteristics of a physical environment surrounding the communication device;
dynamically and adaptively optimizing one or more virtual elements associated with the mixed reality content in real time based on a pre-defined threshold change in the received at least one input of the plurality of inputs, wherein the optimization enables spatial coherence between the one or more virtual elements and the corresponding physical environment captured through the camera module; and
rendering the dynamically optimized mixed reality content based on the pre-defined threshold change, wherein the mixed reality content is rendered using at least one mixed reality module of a plurality of mixed reality modules, wherein the dynamically optimized mixed reality content comprises the one or more virtual elements anchored in accordance with at least a spatial position and orientation of the communication device,
wherein the instructions executed by the one or more processors of the computing device, cause the computing device to enhance processor efficiency and system responsiveness by reducing redundant rendering cycles, optimizing processor–sensor communication throughput, and maintaining real-time frame synchronization through hardware-level adaptation of rendering parameters across the communication device.
